(19) United States
(12) Patent Application Publication
(10) Pub. No.: US 2015/0120534 A1
(43) Pub. Date: Apr. 30, 2015

(54) SYSTEM AND METHOD FOR CONTROLLING A WIRELESS TRACKING DEVICE ALARM

(71) Applicants: Aimee Cardwell, Plymouth, MA (US); Scott Gruby, San Diego, CA (US); David Geisinger, Plymouth, MA (US); Mark Hill, Wellesley, MA (US); Francisco Duarte Barbosa Teixeira e Melo, Newton, MA (US)

(72) Inventors: Aimee Cardwell, Plymouth, MA (US); Scott Gruby, San Diego, CA (US); David Geisinger, Plymouth, MA (US); Mark Hill, Wellesley, MA (US); Francisco Duarte Barbosa Teixeira e Melo, Newton, MA (US)

(21) Appl. No.: 14/523,600

(22) Filed: Oct. 24, 2014

Related U.S. Application Data
(60) Provisional application No. 61/895,692, filed on Oct. 25, 2013.

(51) Int. Cl. G08B 13/24; G06Q 20/12; G06Q 10/08; G06Q 20/42

(52) U.S. Cl. CPC G08B 13/246; G06Q 20/42; G06Q 20/12; G06Q 10/0837
USPC 705/39; 340/539.13; 705/330; 705/340

(57) ABSTRACT

A wireless tracking device may have a unique identifier that identifies the item to which it is attached, distinguishing that item from the other items in a secured location. A database may contain information regarding the item attached to the wireless tracking device. A store may be a secured location, and an item may be authorized to leave the store when it is sold. A checkout process may include scanning a machine-readable code associated with the wireless tracking device. Once the checkout is complete and the customer has paid for the item, the database may be updated to disable the alarm for the wireless tracking device. Based on the information in the database, a wireless tracking device detector may determine whether or not to generate an alarm when the wireless tracking device is detected leaving the secured location.

### CLAIM OF PRIORITY

This application claims the benefit of the filing date of U.S. Provisional Patent Application Ser. No. 61/895,692, filed Oct. 25, 2013 entitled, SYSTEM AND METHOD FOR CONTROLLING A WIRELESS TRACKING DEVICE ALARM,” the entire content of which is incorporated herein by reference.

### TECHNICAL FIELD

The subject matter disclosed herein generally relates to a wireless tracking system. Specifically, in one example, the present disclosure addresses a system for controlling an alarm for a wireless tracking device.

### BACKGROUND

Radio frequency identification (“RFID”) tags can be used for inventory control. Each item in the inventory has an RFID tag placed on it that indicates information about the item. An RFID detector is placed near the exit of the store selling the item. The RFID detector detects when each RFID tag leaves the store and prompts an appropriate response. For example, when an RFID-tagged item leaves a store, an alarm may be triggered.

RFID tags can be used as part of a checkout process. An RFID detector is placed near the cashier. The RFID detector detects each RFID tag in a shopper's basket and updates the checkout information. By using RFID, the cashier saves time over older barcode scanning technologies. The cashier may remove or disable the RFID tag when the item is sold to prevent the item from triggering the alarm when the shopper leaves the store.

### BRIEF DESCRIPTION OF THE DRAWINGS

Some embodiments are illustrated by way of example and not limitation in the figures of the accompanying drawings.

FIG. 1 is a block diagram illustrating an example of a network environment for controlling a wireless tracking device alarm, according to particular disclosed embodiments.

FIG. 2 is a block diagram illustrating components of a server machine for controlling a wireless tracking device alarm, according to particular disclosed embodiments.

FIG. 3 is a block diagram illustrating components of a user device for controlling a wireless tracking device alarm, according to particular disclosed embodiments.

FIG. 4 is a block diagram illustrating a user interface for controlling a wireless tracking device alarm, according to particular disclosed embodiments.

FIG. 5 is a block diagram illustrating a database schema for use in a system controlling a wireless tracking device alarm, according to particular disclosed embodiments.

FIG. 6 is a flow diagram illustrating operations of a server machine in controlling a wireless tracking device alarm, according to particular disclosed embodiments.

FIG. 7 is a flow diagram illustrating operations of a server machine in controlling a wireless tracking device alarm, according to particular disclosed embodiments.

FIG. 8 is a block diagram illustrating an example computer system architecture.

### DETAILED DESCRIPTION

Example methods and systems are directed to controlling a wireless tracking device alarm. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

This specification discusses items and singletons throughout. As used herein, an “item” refers to a physical item at the level of granularity of inventory tracking For example, a large black T-shirt of Brand X is a different item from a large black T-shirt of Brand Y and is also a different item from a medium black T-shirt of Brand X. A “singleton” refers to a particular individual item. Thus, while two large black Brand X T-shirts are interchangeable as items, they are distinct singletons.

A store may use wireless tracking devices (e.g., RFID tags, Bluetooth Low Energy devices, near-field communication (“NFC”) tags, and the like) to track items and reduce theft. For example, each singleton in the store may have a wireless tracking device attached to it, and the exits to the store may have wireless tracking device detectors (e.g., RFID detectors, Bluetooth devices, NFC devices, and so on) to detect when a wireless tracking device is being removed from the store. The wireless tracking device (also referred to herein as a “tag”) may have a unique identifier that uniquely identifies the singleton to which it is attached, distinguishing that singleton from the other singletons in the store. The detector may be in communication with a database, or in communication with a server in communication with a database. The database may contain information regarding the singleton attached to the tag. Based on the information in the database, the detector or the server may determine whether or not to generate an alarm when a tag is detected leaving the store.

The database may be updated when a singleton is authorized to leave the protected area. For example, when a singleton in a store is sold, the entry for the singleton's tag may be updated to indicate that no alarm should be generated if the tag is detected leaving the store. The singleton may be sold to a customer by a cashier, the customer may complete a self-checkout process, or the singleton may be sold by some other technique. The self-checkout process may be at a kiosk, through the use of a customer's device (e.g., a smartphone), or by some other technique.

The checkout process may include scanning a machine-readable code (e.g., a bar code or a quick response (“QR”) code) associated with the tag. For example, a bar code encoding a value may be printed and placed on a paperboard tag attached to the singleton. The checkout scanner may scan the bar code, the customer may photograph the bar code with a smartphone, or other techniques may be used to read the bar code. Based on the bar code, the wireless tracking device may be identified. For example, each wireless tracking device may have a unique value and the same value may be encoded in the bar code. In another example, a lookup table is used to identify the wireless tracking device corresponding to the bar code. Once the checkout is complete and the customer has paid for the singleton, the database can be updated to disable the alarm for the tag.

In some example embodiments, the tag is read directly during the checkout process rather than identified via a lookup. For example, an RFID detector may be built into the checkout stand or provided to a cashier in a hand-held device. The RFID tags of the singletons selected for purchase are detected and the corresponding singletons identified. As above, once the checkout is complete and the customer has paid for the singleton, the database can be updated to disable the alarm for the wireless tracking device.

The database may be updated when a singleton is no longer authorized to leave the protected area. For example, when a singleton is returned to a store, the entry for the singleton's tag may be updated to indicate that an alarm should be generated if the tag is detected leaving the store. As discussed above, the tag may be identified by the use of a machine-readable code. The checkout scanner may scan the machine-readable code, the customer may photograph the machine-readable code with a smartphone, or other techniques may be used to read the machine-readable code. Based on the machine-readable code, the tag may be identified. Once the checkout is complete and a refund issued for the item, the database may be updated to enable the alarm for the tag.

The database may be updated to reflect different alarm values or other responses to be generated by the detector. For example, detection of tags associated with singletons may generate a flashing light, an audible sound, both a light and a sound, etc. The color, duration, and intensity of the light may vary. The pitch, loudness, and duration of the sound may vary. For example, a high-value singleton may trigger a loud warning sound if the associated tag is detected leaving the protected area, while a low-value singleton may trigger a silently flashing light.

While the above description relates to the use of a system to reduce theft by controlling a wireless tracking device alarm, other uses of the system are also contemplated. For example, a shipping warehouse may use wireless tracking devices to track singletons and detect if unauthorized singletons are leaving the warehouse. As another example, an indoor capture-the-flag game may have wireless tracking devices in the flags and wireless tracking device detectors in the scoring areas. Additional locations may enable or disable the ability to score.

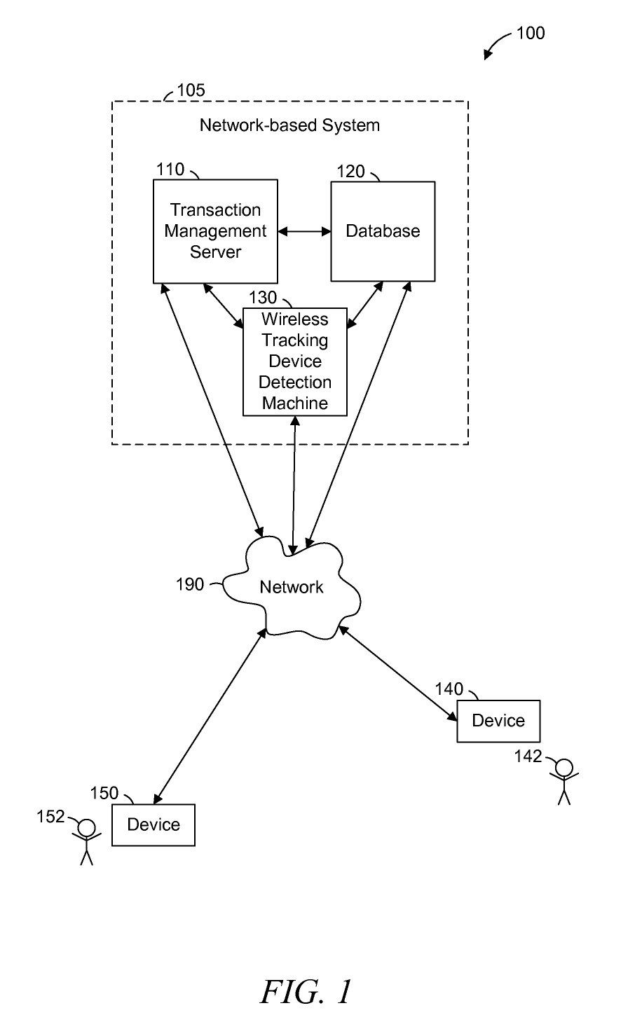

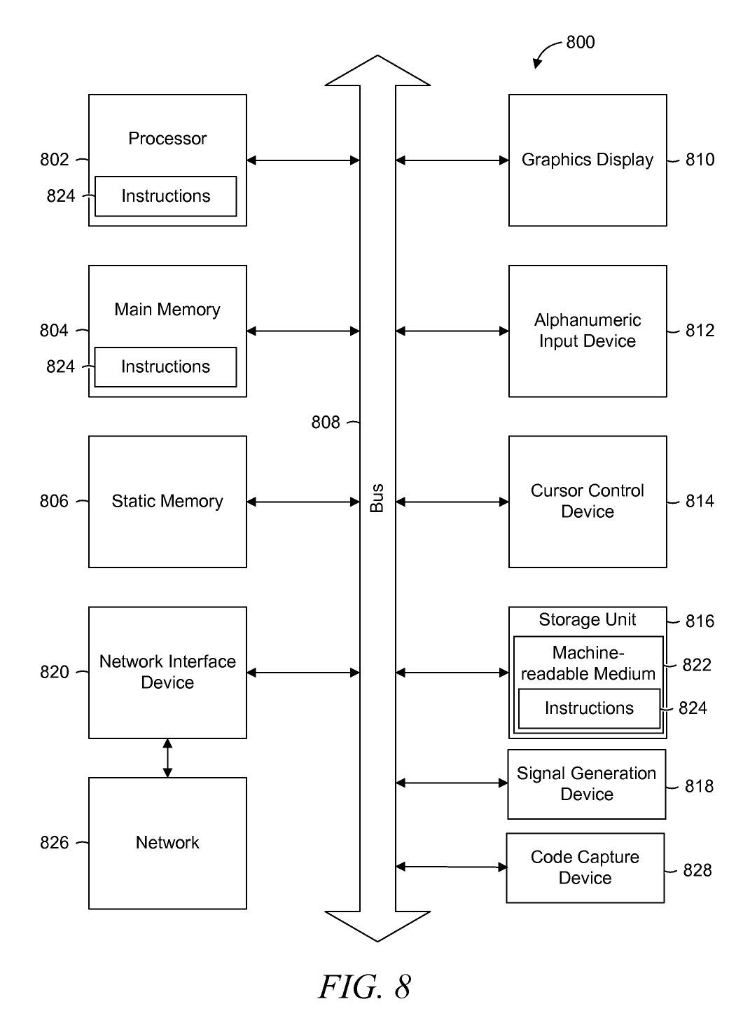

FIG. 1 is a block diagram illustrating an example of a network environment 100 for controlling a wireless tracking device alarm, according to particular disclosed embodiments. The network environment 100 includes a transaction management server 110, a database 120, a wireless tracking device detection machine 130 (together comprising a network-based system 105), a device 140, and a device 150, all communicatively coupled to each other via a network 190. The transaction management server 110, the database 120, the wireless tracking device detection machine 130, and the devices 140 and 150 may each be implemented in a computer system, in whole or in part, as described below with respect to FIG. 8.

The devices 140 and 150 may be used by users 142 and 152 to access services provided by the transaction management server 110. The transaction management server 110 may be the point of contact for the devices 140 and 150 with the network-based system 105. Alternatively, the devices 140 and 150 may communicate directly with the database 120 and the wireless tracking device detection machine 130 as well as (or instead of) the transaction management server 110.

One or both of the users 142 and 152 may be a human user, a machine user (e.g., a computer configured by a software program to interact with one or more of the devices 140 and 150), or any suitable combination thereof (e.g., a human assisted by a machine or a machine supervised by a human). The user 142 is not part of the network environment 100, but is associated with the device 140 and may be a user of the device 140. For example, the device 140 may be a desktop computer, a vehicle computer, a tablet computer, a navigational device, a portable media device, or a smartphone belonging to the user 142. Likewise, the user 152 is not part of the network environment 100, but is associated with the device 150. As an example, the device 150 may be a desktop computer, a vehicle computer, a tablet computer, a navigational device, a portable media device, or a smartphone belonging to the user 152.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 8. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 190 may be any network that enables communication between or among machines, databases, and devices (e.g., the transaction management server 110 and the device 140). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

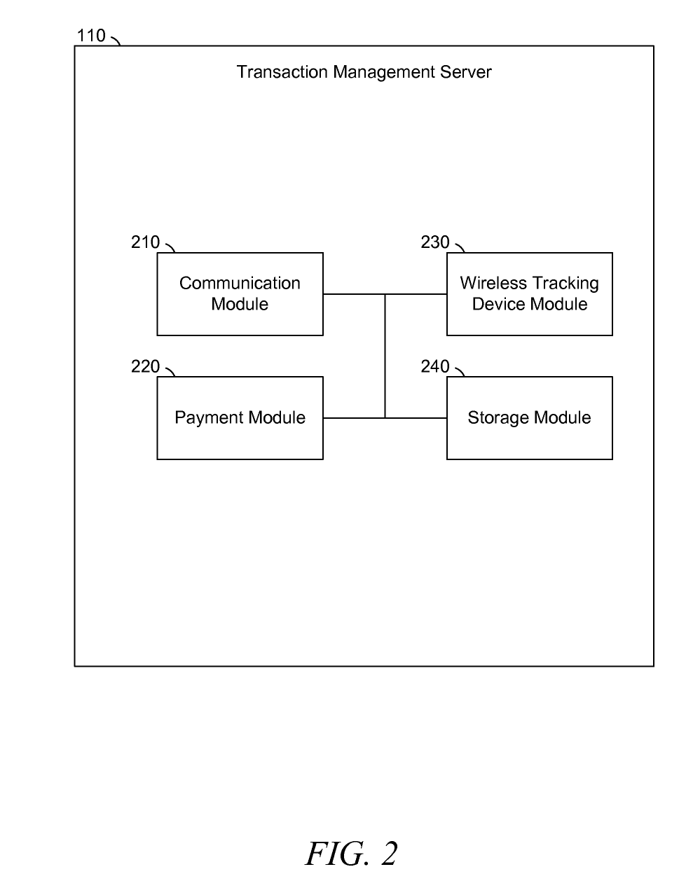

FIG. 2 is a block diagram illustrating components of a transaction management server 110 for controlling a wireless tracking device alarm, according to particular disclosed embodiments. The transaction management server 110 is shown as including a communication module 210, a payment module 220, a wireless tracking device module 230, and a storage module 240, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 is configured to communicate with the device 140 or 150. For example, the device 140 or 150 may scan a machine-readable code for an item and transmit the code to the transaction management server 110, to be received by the communication module 210. The code may be used to retrieve information about the item from the database 120 via the storage module 240. The information about the item may be sent to the device 140 or 150 via the communication module 210 for display. The communication module 210 may also receive payment information from the user device 140 or 150. For example, credit card information or PayPal account information may be received by the communication module 210. The payment module 220 uses the payment information to charge the user for the item, and can also verify that the payment was successful.

The wireless tracking device module 230 identifies the unique wireless tracking device associated with the item identified by the machine-readable code. Based on the payment being successful, the storage module 240 may be informed by the wireless tracking device module 230 that the identified wireless tracking device code should not trigger an alarm. The storage module 240 may create or update a record in a database corresponding to the identified wireless tracking device code to record the fact that the identified wireless tracking device code should not trigger an alarm.

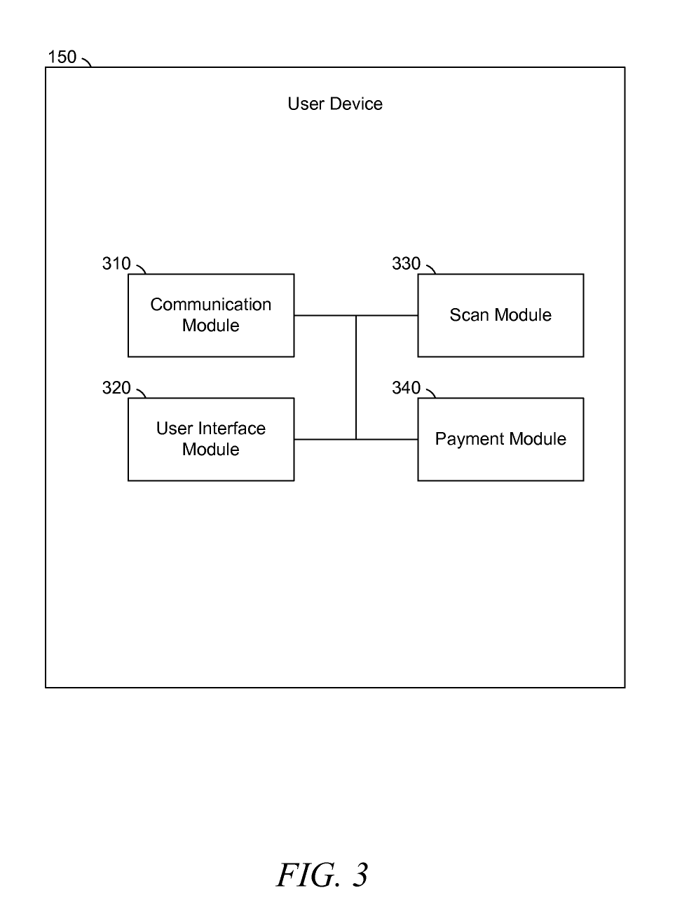

FIG. 3 is a block diagram illustrating components of a user device 150 for controlling a wireless tracking device alarm, according to particular disclosed embodiments. The device 150 is shown as including a communication module 310, a user interface module 320, a scan module 330, and a payment module 340, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The user interface module 320 presents a user interface to a user on a display device. The user interface may prompt the user to scan a machine-readable code for a singleton. The scan module 330 scans the machine-readable code for the singleton. The value of the machine-readable code or an image of the machine-readable code may be transmitted to the transaction management server 110 via the communication module 310. The communication module 310 may receive information about the item (e.g., description, image, price, etc.). The user interface module 320 may present the information about the item to the user and prompt the user to provide payment information to pay for the singleton. The payment module 340 may receive payment information from the user. For example, the payment information may already be stored on the user device 150, scanned by a card reader attached the user device 150, keyed into the user device 150 by the user, etc. The payment information may be sent to the transaction management server 110 by the communication module 310, and approval of the transaction may be received by the communication module 310. After the approval is received, the user interface module 320 may present a confirmation of the purchase to the user on the user interface.

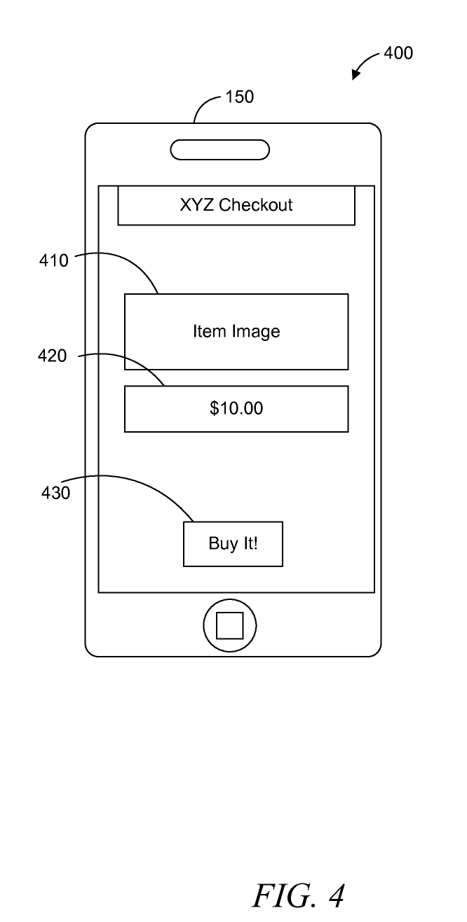

FIG. 4 is a block diagram illustrating a user interface 400 on the device 150 for controlling a wireless tracking device alarm, according to particular disclosed embodiments. FIG. 4 shows the user interface 400 including a title, an item image 410, an item price 420, and a purchase button 430. The title may indicate the store, the item, the user, or any suitable combination thereof. The item image 410 may show a still or moving image of the item or the machine-readable code. The item price 420 may display the price of the item. The purchase button 430 may be operable to purchase the item, e.g., by sending stored account information along with information about the item being purchased to the transaction management server 110. In some example embodiments, multiple items are added to a shopping cart and a purchase action purchases all of the items in the shopping cart.

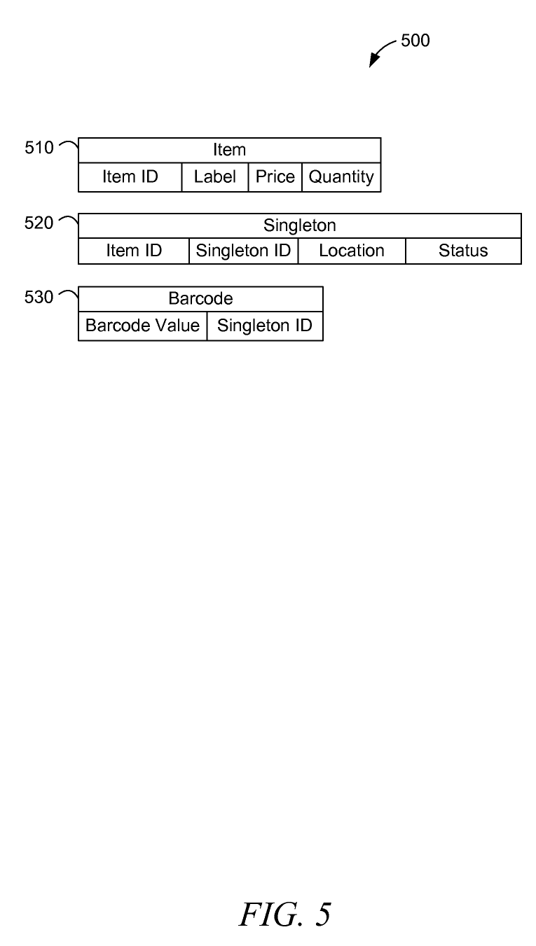

FIG. 5 is a block diagram illustrating a database schema 500 for use in a system controlling a wireless tracking device alarm, according to particular disclosed embodiments. The database schema 500 comprises an item table 510, a singleton table 520, and a barcode table 530.

The item table 510 includes item identifier, label, price, and quantity fields. Each different type of item has one row in the item table 510. For example, plain T-shirts of a particular brand would have one entry for each size and color of shirt. A library of books could have one entry for each title, or one entry for each publication of each title. Put another way, the rows of the item table 510 provide information at the level at which inventory is tracked. The quantity field of the item table 510 contains the current quantity of the item.

The singleton table 520 provides an additional level of detail. Each row in the singleton table 520 contains information for a particular single item, including an item identifier, a singleton identifier, and a status. Thus, if there are 5 large black T-shirts on hand, there is one row in the item table 510 and 5 corresponding rows in the singleton table 520. The item identifier in each row of the singleton table 520 indicates the corresponding row in the item table 510. The singleton identifier is a unique identifier for the particular single item. For example, the singleton identifier may be a value reported by an RFID tag affixed to the particular single item. The status field contains status information for the particular single item. In various embodiments, more, fewer, or different status values may be used. In an example embodiment, the values below are used:

| Value | Meaning |
|---|---|
| 0 | Not yet received |
| 1 | Unsold |
| 2 | Sold |

A supplier of a retailer may apply a unique tag to each item delivered to the retailer. The mapping between the tags and the items may be provided by the supplier to the retailer prior to receipt of the items by the retailer. The retailer can update its database to include the items scheduled for delivery in the singleton table 520. The status of the items may be set to “not yet received” to indicate that the items are expected but not yet in inventory.

When the items arrive at the retailer, the RFID tags are detected and the corresponding rows in the singleton table 520 are updated to show that the items are “unsold.” Alternatively, if the supplier does not apply tags before shipment, the retailer can apply tags when the items are received and the “not yet received” status may go unused.

If an item with the “unsold” status is detected leaving the store, an alarm may sound or other indication made that an unauthorized departure of an item is occurring. When the item is sold, the status is updated to “sold,” and no alarm sounds when the item leaves the store.

In some example embodiments, additional information about the singleton is stored in the singleton table 520. For example, a location field can be used to track the location of the singleton within the establishment. In this way, the number of items in a primary location (e.g., in an aisle) can be tracked separately from the number of items in a promotional location (e.g., in an endcap). Accordingly, if the items being sold deplete the inventory from one location, an alert can be generated to suggest moving items from the other location to the depleted location. Similarly, in a warehouse environment, tracking the location of each singleton can reduce time spent searching for items, putting orders together, and so on.

The barcode table 530 contains information that maps a machine-readable code to the singleton identifier. For example, the machine-readable code may be a barcode and the singleton identifier may be the value of an RFID tag. As another example, the machine-readable code may be a QR code and the singleton identifier may be the value reported by a Bluetooth Low Energy device attached to the singleton. Using the barcode table 530, the singleton identifier does not have to be read directly from the singleton. Instead, a different (e.g., already installed or less-expensive) scanning device can be used, and the singleton identified by using the mapping in the barcode table 530.

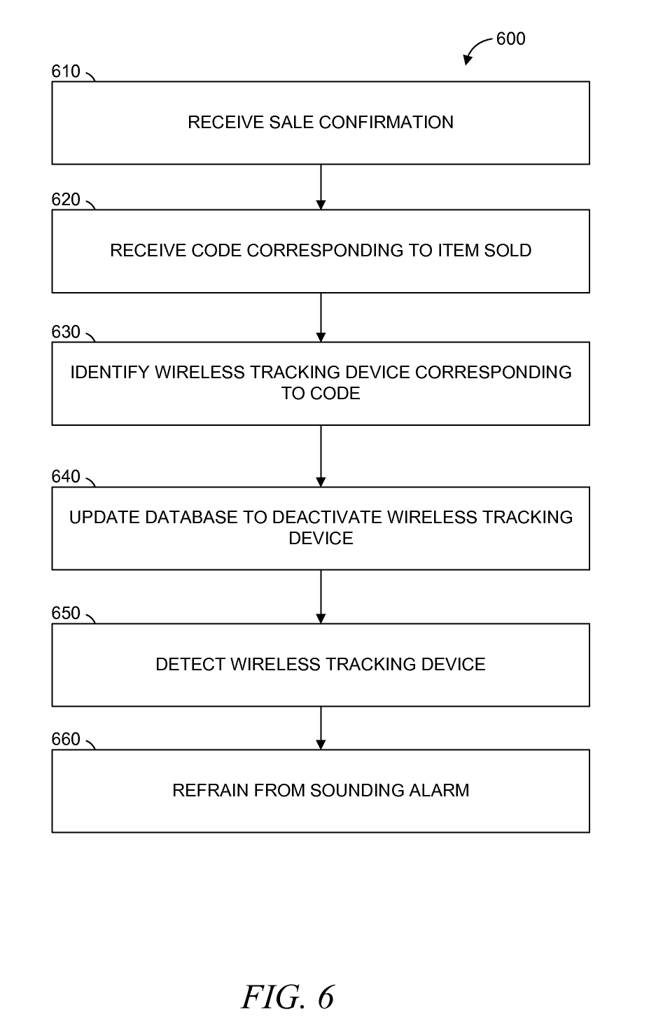

FIG. 6 is a flow diagram illustrating a method 600 comprising operations of a network-based system 105 in controlling a wireless tracking device alarm, according to particular disclosed embodiments. While the various operations of the method 600 are described with reference to the transaction management server 110 of FIG. 2, the wireless tracking device detection machine 130 of FIG. 1, and the device 150 of FIG. 3, other devices or systems may be employed to perform the method 600 in other embodiments. As shown in FIG. 6, the method 600 includes operations 610, 620, 630, 640, 650, and 660.

In the method 600, the transaction management server 110 receives a confirmation that an item has been sold (operation 610), e.g., by using the communication module 210 to receive a transaction approval from a financial institution. For example, an account identifier for an account (e.g., a savings account, a checking account, a credit card account, or other financial account) at the financial institution may have been received from a device 140 or 150 and a transaction submitted to transfer the price of the item from the account to the store's account. The transaction management server 110 receives a code corresponding to the item (operation 620), e.g., by receiving the value of a machine-readable code scanned by the device 140 or 150. The transaction management server 110 identifies a tag corresponding to the code (operation 630), e.g., by accessing a record in the barcode table 530 of the database 120 showing the correspondence between the tag and the code.

The database 120 is updated by the transaction management server 110 (operation 640) to deactivate the tag. For example, a value in the status field of the record in the singleton table 520 for the tag may be changed to indicate that the tag should not set off an alarm. The wireless tracking device detection machine 130 may detect the tag (operation 650). For example, the customer may take the item with the tag through the exit doors and pass through a detector. The wireless tracking device detection machine 130 accesses the database 120 to determine if the detection of the RFID tag should set off an alarm. Based on the status field of the row in the singleton table 520 having a singleton identifier matching the value provided by the tag indicating that the tag should not set off the alarm, the wireless tracking device detection machine 130 refrains from setting off the alarm (operation 660).

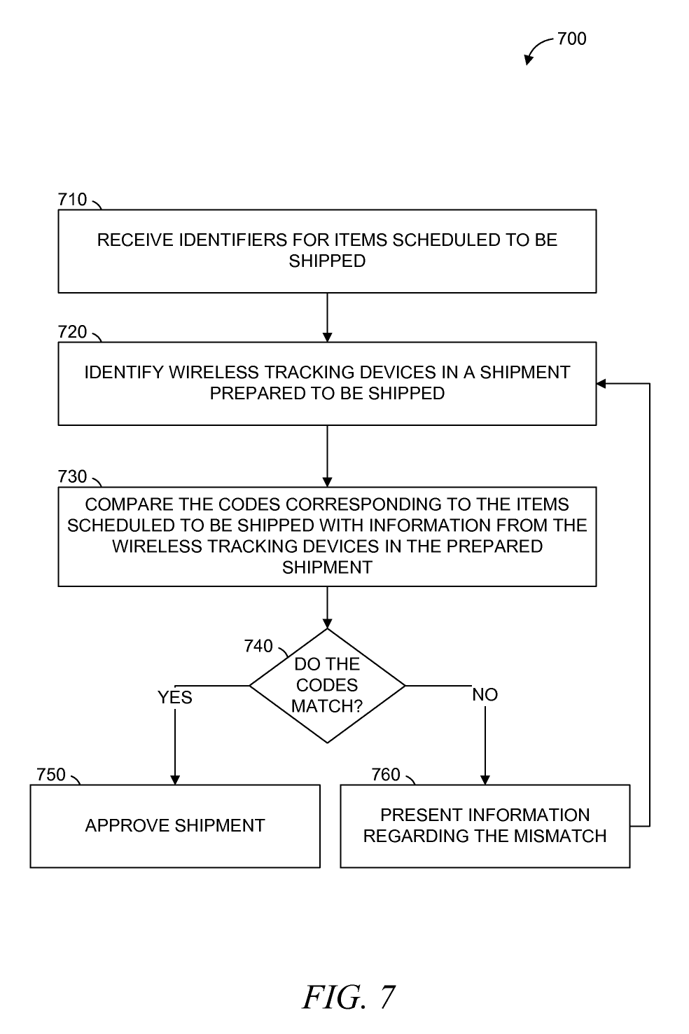

FIG. 7 is a flow diagram illustrating a method 700 comprising operations of a network-based system 105 in approving an order for shipment, according to particular disclosed embodiments. While the various operations of the method 700 are described with reference to the transaction management server 110 of FIG. 2, the wireless tracking device detection machine 130 of FIG. 1, and the device 150 of FIG. 3, other devices or systems may be employed to perform the method 700 in other embodiments. As shown in FIG. 7, the method 700 includes operations 710, 720, 730, 740, 750, and 760.

In operation 710, item identifiers for items scheduled to be shipped are received by the transaction management server 110. For example, a set of item identifiers in the item table 510 may be received, corresponding to an order placed by a customer.

A detector detects the tags in a shipment prepared to be shipped in operation 720. For example, items for the order are placed in a box by warehouse employees and the box is placed in a staging area for a quality-assurance check before being sealed and shipped. A detector in the staging area reads the tags in the box.

The transaction management server 110 identifies the set of items in the prepared shipment using the singleton table 520 to convert from singleton identifiers to item identifiers (operation 730). The set of item identifiers actually prepared for shipment is compared to the set of item identifiers received in operation 710.

If the sets match (operation 740), then the shipment is approved (operation 750). For example, a green light may indicate that the shipment is approved, a positive audio signal such as a bell or “ding” sound may be given, or the user interface module of the device 150 may display an “OK” message on the device. If the sets do not match, then information regarding the mismatch is presented (operation 760). For example, a red light may indicate that the shipment is rejected, a negative audio signal such as a buzz may be given, or the user interface module of the device 150 may display an error message, inform the user as to which items are missing or which extraneous items are present, and so on. If the set of item identifiers did not match, the method 700 returns to operation 720 or operation 710 after the user fixes the problem with the shipment and attempts again to get the shipment approved.

According to various example embodiments, one or more of the methodologies described herein may facilitate controlling an RFID alarm. The controlling of a wireless tracking device alarm for a wireless tracking device may facilitate a customer's self-checkout process without requiring a tool to remove the wireless tracking devices from products, resulting in faster checkouts and lower labor costs. The controlling of a wireless tracking device alarm for a wireless tracking device may facilitate inventory management in a warehouse, by allowing properly scanned items to leave the facility without triggering an alarm while raising an alarm for other items.

The controlling of a wireless tracking device alarm for a wireless tracking device may facilitate the relocation of items between various storage and retail locations. For example, an item may be tagged at a storage location and configured to raise an alarm if taken out of the storage location. The item may be scanned at the storage location and configured to not raise an alarm if taken out of the storage location. The item may be taken from the storage location to a retail location, scanned, and configured to raise an alarm if taken out of the retail location. This process may improve efficiency by allowing the items to be protected at both the storage location and the retail location while only requiring the wireless tracking device to be added once.

FIG. 8 is a block diagram illustrating components of a machine 800, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 8 shows a diagrammatic representation of the machine 800 in the example form of a computer system within which instructions 824 (e.g., software, a program, an application, an applet, an app, or other executable code) for causing the machine 800 to perform any one or more of the methodologies discussed herein may be executed, in whole or in part. In alternative embodiments, the machine 800 operates as a standalone device or may be connected (e.g., networked) to other machines. In a networked deployment, the machine 800 may operate in the capacity of a server machine or a client machine in a server-client network environment, or as a peer machine in a distributed (e.g., peer-to-peer) network environment. The machine 800 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 824, sequentially or otherwise, that specify actions to be taken by that machine. Further, while only a single machine is illustrated, the term “machine” shall also be taken to include a collection of machines that individually or jointly execute the instructions 824 to perform all or part of any one or more of the methodologies discussed herein.

The machine 800 includes a processor 802 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 804, and a static memory 806, which are configured to communicate with each other via a bus 808. The machine 800 may further include a graphics display 810 (e.g., a plasma display panel (PDP), a light emitting diode (LED) display, a liquid crystal display (LCD), a projector, or a cathode ray tube (CRT)). The machine 800 may also include an alphanumeric input device 812 (e.g., a keyboard), a cursor control device 814 (e.g., a mouse, a touchpad, a trackball, a joystick, a motion sensor, or other pointing instrument), a storage unit 816, a signal generation device 818 (e.g., a speaker), a network interface device 820, and a code capture device 828 (e.g., a camera, a barcode scanner, or another code detecting device).

The storage unit 816 includes a machine-readable medium 822 on which are stored the instructions 824 embodying any one or more of the methodologies or functions described herein. The instructions 824 may also reside, completely or at least partially, within the main memory 804, within the processor 802 (e.g., within the processor's cache memory), or both, during execution thereof by the machine 800. Accordingly, the main memory 804 and the processor 802 may be considered machine-readable media. The instructions 824 may be transmitted or received over a network 826 (e.g., network 190) via the network interface device 820.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 822 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 800), such that the instructions, when executed by one or more processors of the machine (e.g., processor 802), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electrical, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving a confirmation regarding a singleton, the confirmation including a value read from a machine-readable code associated with the singleton;
detecting a wireless tracking device, using a processor of a machine, corresponding to the value read from the machine-readable code; and
based on having received the confirmation regarding the singleton, refraining from generating an alarm in response to the detection of the wireless tracking device.

2. The method of claim 1, wherein the confirmation regarding the singleton comprises a confirmation that a sale of the singleton is successful.

3. The method of claim 2 further comprising, prior to the receiving of the confirmation that the sale of the singleton is successful:
receiving the value read from the machine-readable code associated with the singleton;
causing information about the singleton to be presented on a display device, the information including a price of the singleton;
receiving account information for an account of a buyer of the item singleton; and
charging the account the price of the singleton.

4. The method of claim 2, further comprising:
receiving a confirmation that the singleton has been returned, the confirmation including the value read from the machine-readable code associated with the singleton;
repeating the detection of the wireless tracking device corresponding to the value read from the machine-readable code; and
based on having received the confirmation that the singleton has been returned, generating the alarm in response to the repeated detection of the wireless tracking device

5. The method of claim 4, further comprising:
based on the value read from the machine-readable code, selecting an attribute of the alarm from a plurality of options.

6. The method of claim 1 further comprising:
storing the value read from the machine-readable code in a database; and wherein
the detecting of the wireless tracking device corresponding to the value read from the machine-readable code includes:
identifying a value corresponding to the wireless tracking device; and
comparing the value corresponding to the wireless tracking device with the value read from the machine-readable code in the database.

7. The method of claim 1, wherein the wireless tracking device comprises an RFID tag.

8. A system comprising:
a communication module configured to receive a first set of item identifiers;
a wireless tracking device module configured to:
detect a set of wireless tracking devices, each wireless tracking device of the set of wireless tracking devices identifying a singleton;
determine, based on the singletons, a second set of item identifiers; and
compare the first set of item identifiers to the second set of identifiers; and
a user interface module configured to:
cause a presentation of a result of the comparison.

9. The system of claim 8, wherein:
the result of the comparison is a mismatch between the first set of item identifiers and the second set of identifiers.

10. The system of claim 9, wherein the causing of the presentation of the result of the comparison comprises causing the presentation of names of items corresponding to mismatched item identifiers in the first set of item identifiers and the second set of item identifiers.

11. The system of claim 8, wherein:
the result of the comparison is a match between the first set of item identifiers and the second set of item identifiers.

12. The system of claim 11, wherein the causing of the presentation of the result of the comparison comprises causing the presentation of an authorization to ship a set of items to which the set of wireless tracking devices are attached.

13. The system of claim 8, wherein the wireless tracking devices comprise Bluetooth low-energy devices.

14. A non-transitory machine-readable storage medium comprising instructions that, when executed by one or more processors of a machine, cause the machine to perform operations comprising:
receiving a confirmation regarding a singleton, the confirmation including a value read from a machine-readable code associated with the singleton;
detecting a wireless tracking device, using a processor of a machine, corresponding to the value read from the machine-readable code;
based on the value read from the machine-readable code, selecting an alarm from a plurality of alarms; and
based on the detection of the wireless tracking device, generating the selected alarm.

15. The non-transitory machine-readable storage medium of claim 14, wherein the confirmation regarding the singleton comprises a confirmation that a sale of the singleton is successful.

16. The non-transitory machine-readable storage medium of claim 15, wherein the operations further comprise:
prior to the receiving of the confirmation that the sale of the singleton is successful:
receiving the value read from the machine-readable code associated with the singleton;
causing information about the singleton to be presented on a display device, the information including a price of the singleton;
receiving account information for an account of a buyer of the item singleton; and
charging the account the price of the singleton.

17. The non-transitory machine-readable storage medium of claim 15, wherein the operations further comprise:
receiving a confirmation that the singleton has been returned, the confirmation including the value read from the machine-readable code associated with the singleton;
repeating the detection of the wireless tracking device corresponding to the value read from the machine-readable code;
based on the value read from the machine-readable code and the confirmation that the singleton has been returned, selecting a second alarm from the plurality of alarms; and
in response to the repeated detection of the wireless tracking device, generating the second alarm.

18. The non-transitory machine-readable storage medium of claim 14, wherein the operations further comprise:
storing the value read from the machine-readable code in a database; and wherein
the detecting of the wireless tracking device corresponding to the value read from the machine-readable code includes:
identifying a value corresponding to the wireless tracking device; and
comparing the value corresponding to the wireless tracking device with the value read from the machine-readable code in the database.

19. The non-transitory machine-readable storage medium of claim 14, wherein the wireless tracking device comprises a near-field communications device.

20. The non-transitory machine-readable storage medium of claim 14, wherein the machine-readable code is a QR code.
